(19) United States
(12) Patent Application Publication
(10) Pub. No.: US 2007/0274414 A1
(43) Pub. Date: Nov. 29, 2007

(54) Communication device

(75) Inventor: Tomoaki Ohara, Nagoya-shi (JP)

Correspondence Address: BEYER WEAVER LLP, P.O. BOX 70250, OAKLAND, CA, 94612-0250, US

(73) Assignee: BUFFALO INC.

(21) Appl. No.: 11/598,224

(22) Filed: Nov. 8, 2006

(30) Foreign Application Priority Data
Nov. 10, 2005 (JP) 2005-325993

(51) Int. Cl. H04L 25/03

(52) U.S. Cl. 375/296

(57) ABSTRACT

To provide a technology for suppressing emission of stronger radio wave due to a mismatched combination of a communication device with an external antenna module. A communication device comprises: a connector that is connected to an external antenna module; a generating section that generates a transmitting signal of a specific frequency band, the transmitting signal being supplied to the antenna module via the connector; an acquiring section that acquires information relating to antenna gain from the antenna module; and a controlling section that executes predetermined processing on the basis of the information relating to antenna gain, such that strength of radio wave emitted from the antenna module responsive to the transmitting signal does not exceed an upper limit value defined for the specific frequency band.

### CROSS-REFERENCE TO RELATED APPLICATIONS

The present application claims the priority based on Japanese Patent Application No. 2005-325993 filed on Nov. 10, 2005, the disclosure of which is hereby incorporated by reference in its entirety.

### BACKGROUND

1. Technical Field

The present invention relates to a communication device, and relates in particular to technology for a communication device to which an external antenna module is connected.

2. Related Art

Recently, wireless communication devices are widespread used. It is typically necessary that outputs of wireless communication devices satisfy prescribed standards, and these standards are established for each frequency band used by such devices.

In the case of wireless LAN devices for example, radio wave of 2.4 GHz frequency band is used. In Japan, wireless LAN devices using radio wave of 2.4 GHz frequency band need to satisfy standards of Low Power Data Communications System. For example, if a communication device uses radio wave of 2.471-2.497 GHz for example, the output power of the communication device is restricted to no more than 10 mW/MHz, and antenna gain of the communication device is restricted to no more than 2.14 dBi.

In a wireless communication device to which an external antenna module is to be connected, there is a risk of a mismatch when a communication device and an antenna module are combined. For example, there is a risk that a communication device that uses radio wave of 2.471-2.497 GHz could be mistakenly connected to an antenna module having high antenna gain suitable for another communication device that uses radio wave of a different frequency band (e.g. 2.40-2.4835 GHz). Where the combination of the communication device and the antenna module fail to be properly matched in this way, there is a risk that the communication device will emit stronger radio wave that does not satisfy the standards.

For this reason, in communication devices to which an external antenna module is to be connected, a predetermined external antenna module is only allowed to be connected to a communication device, by modifying shape of a connector (e.g. by using a dedicated connector).

However, the types of frequency bands available has been increasing, and modifying the shapes of connectors is a laborious task. Moreover, if limited types of connectors in existence are to be used, selection of connector shape is limited.

Accordingly, there is a need for technology for suppressing emission of stronger radio wave due to a mismatched combination of a communication device with an external antenna module, by other method that is not dependent on connector shape.

### SUMMARY

The present invention solves the above described problem of related art, and an object of the invention is to provide a technology for suppressing emission of stronger radio wave due to a mismatched combination of a communication device with an external antenna module.

At least part of the above and the other related objects is attained by an apparatus of the present invention. The apparatus is a communication device to which an external antenna module is to be connected. The communication device comprises: a connector that is connected to the antenna module; a generating section that generates a transmitting signal of a specific frequency band, the transmitting signal being supplied to the antenna module via the connector; an acquiring section that acquires information relating to antenna gain from the antenna module; and a controlling section that executes predetermined processing on the basis of the information relating to antenna gain, such that strength of radio wave emitted from the antenna module responsive to the transmitting signal does not exceed an upper limit value defined for the specific frequency band.

In this apparatus, the predetermined processing is executed on the basis of the information relating antenna gain acquired from the external antenna module, so that the strength of radio wave emitted from the antenna module does not exceed the upper limit value defined for the specific frequency band, whereby it is possible to suppress emission of stronger radio wave due to a mismatched combination of a communication device with an external antenna module

It should be noted that the present invention may be actualized by a diversity of applications such as a communication device, a communication device including an antenna module, control methods in these devices, computer programs that attain these methods or functions of these devices, recording media in which such computer programs are recorded, and data signals that include such computer programs and are embodied in carrier waves.

These and other objects, features, aspects, and advantages of the present invention will become more apparent from the following detailed description of the preferred embodiments with the accompanying drawings.

### BRIEF DESCRIPTION OF THE DRAWINGS

FIG. 1 shows an example of a communication system;

FIG. 2 shows the internal arrangement of the access point 100;

FIGS. 3(A) and 3(B) show the internal arrangement of the antenna module 200;

FIG. 4 shows an overview of operation of the access point 100;

FIG. 5 shows the internal arrangement of an access point 100a according to a modification example of the first embodiment;

FIG. 6 shows the internal arrangement of an access point 100B in the second embodiment;

FIG. 7 shows an overview of operation of the access point 100B;

FIG. 8 shows the internal arrangement of the access point 100Ba in the modification example of the second embodiment;

FIG. 9 shows the internal arrangement of an access point 100C in the third embodiment; and

FIG. 10 shows an overview of operation of the access point 100C.

### DESCRIPTION OF THE PREFERRED EMBODIMENT

Embodiments of the present invention are discussed below based on examples in the following order.

### A. First Embodiment

A-1. Arrangement of Communication System:

A-1-1. Internal Arrangement of Access Point:

A-1-2. Internal Arrangement of Antenna Module:

A-2. Standards:

A-3. Operation of Access Point:

A-3-1. Operation If Usage frequency band Is First Frequency Band:

A-3-2. Operation If Usage frequency band Is Second Frequency Band:

A-4. Modification Example of First Embodiment:

### B. Second Embodiment

B-1. Internal Arrangement of Access Point:

B-2. Operation of Access Point:

B-2-1. Operation If Usage frequency band Is First Frequency Band:

B-2-2. Operation If Usage frequency band Is Second Frequency Band:

B-3. Modification Example of Second Embodiment:

### C. Third Embodiment

C-1. Internal Arrangement of Access Point:

C-2. Operation of Access Point:

C-2-1. Operation If Usage frequency band Is First Frequency Band:

C-2-2. Operation If Usage frequency band Is Second Frequency Band:

### A. First Embodiment

A-1. Arrangement of Communication System:

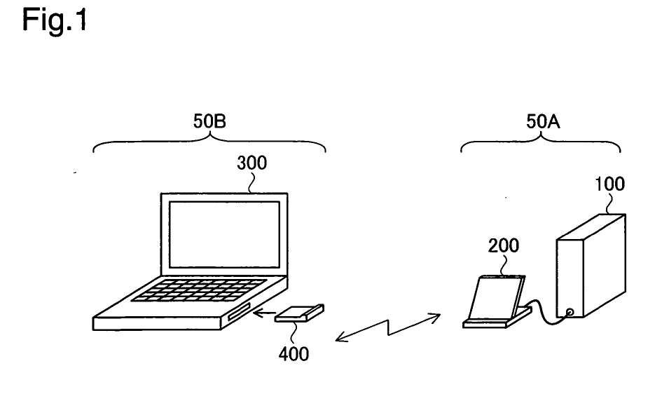

FIG. 1 shows an example of a communication system. In FIG. 1, two communication devices 50A and 50B are shown. The first communication device 50A is an access point 100 with an external antenna module 200 connected to it. The second communication device 50B is a computer with a card type communication adaptor 400 installed. Note that the access point is connected to a wired LAN, not shown.

In this embodiment, the two communication devices 50A, 50B communicate wirelessly with one another using 5 GHz frequency band. More specifically, they communicate wirelessly using a first frequency band (5.15-5.35 GHz) or a second frequency band (5.47-5.725 GHz).

Note that the access point 100 of this embodiment corresponds to a communication device of the present invention.

A-1-1. Internal Arrangement of Access Point:

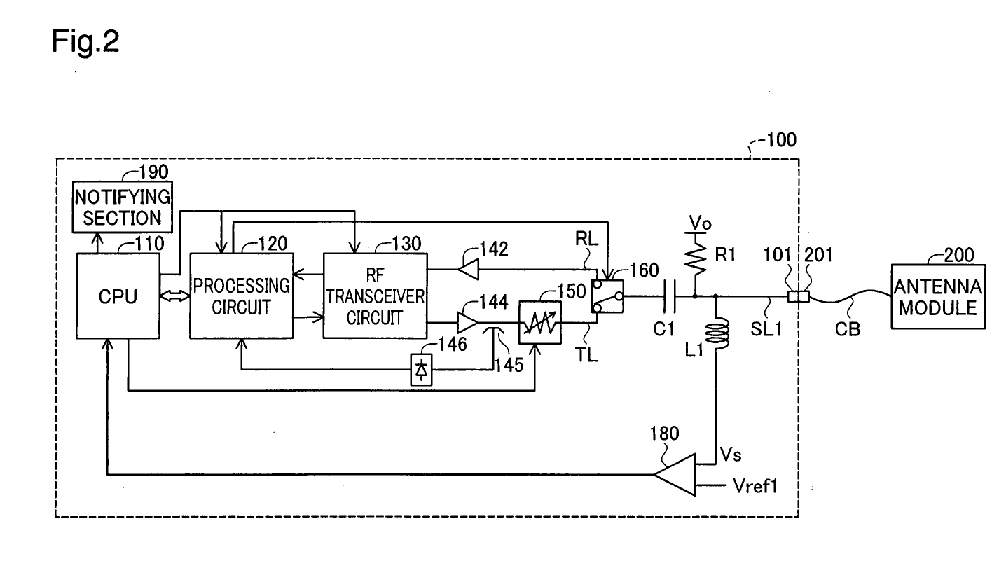

FIG. 2 shows the internal arrangement of the access point 100. As illustrated, the access point (hereinafter also referred to simply as “AP”) 100 comprises a connector 101, and is connected with the external antenna module 200 via this connector 101. Specifically, the AP 100 and the antenna module 200 are connected by joining together the connector 101 of the AP 100 with a connector 201 provided at the distal end of a cable CB belonging to the antenna module 200.

The AP 100 also comprises a CPU 110, a processing circuit 120, an RF (radio frequency) transceiver circuit 130, a switching circuit 160, and a notifying section 190. The CPU 110 and the processing circuit 120 are interconnected by a bus (e.g. a PCI bus).

The RF transceiver circuit 130 and the switching circuit 160 are connected via a signal line for reception use RL and a signal line for transmission use TL. A first amplifier 142 is disposed on the receive signal line RL. A second amplifier 144 and a reducing circuit 150 are disposed on the transmit signal line TL.

The switching circuit 160 and the connector 101 are connected via a common signal line SL1. The common signal line SL1 is utilized as a signal line for both transmission use and reception use. A comparator 180 is connected to the common signal line SL1.

The processing circuit 120 is also referred to as a BB & MAC circuit, and executes processes for MAC (Media Access Control) layer and processes for PHY (physical) layer. MAC layer processes are implemented by a MAC controller (not shown) within the processing circuit 120. PHY layer processes are implemented by a modulation circuit, demodulation circuit, AD (analog-digital) converter, DA (digital-analog) converter, etc. (not shown) within the processing circuit 120. During transmission, the processing circuit 120 generates an analog baseband signal from a digital signal, while during receiving it reproduces a digital signal from an analog baseband signal. This analog baseband signal is also referred to as a modulation signal.

The RF transceiver circuit 130 comprises a transmitting circuit and a receiving circuit, not shown. The transmitting circuit includes a mixer, and varies a carrier wave according to the analog baseband signal received from the processing circuit 120, to generate a modulated wave (modulated signal). The receiving circuit includes a mixer, and eliminates a carrier wave from a received modulated wave (modulated signal) to reproduce the analog baseband signal.

In this embodiment, the RF transceiver circuit 130 is capable of generating carrier waves of two types of frequencies in the 5 GHz band. As a result, the RF transceiver circuit 130 can generate a modulated wave of a first frequency band (5.15-5.35 GHz) and a modulated wave of a second frequency band (5.47-5.725 GHz).

The switching circuit 160 includes an analog switch of SPDT (Single Pole Double Throw) type. If the switching circuit 160 is set to a first state, the modulated wave (modulated signal) output from the RF transceiver circuit 130 is supplied to the antenna module 200 via the transmit signal line TL. If the switching circuit 160 is set to a second state, the modulated wave (modulated signal) received by the antenna module 200 is supplied to the RF transceiver circuit 130 via the receive signal line RL. The state of the switching circuit 160 is controlled by the processing circuit 120. Note that in FIG. 2, the switching circuit 160 is shown set to the first state, establishing a state in which the modulated wave (modulated signal) can be transmitted to the antenna module 200.

The first amplifier 142 is an amplifier for reception use, and amplifies the modulated wave (modulated signal) supplied to the RF transceiver circuit 130. The second amplifier 144 is an amplifier for transmission use, and amplifies the modulated wave (modulated signal) supplied from the RF transceiver circuit 130.

The reducing circuit 150 is disposed between the second amplifier 144 and the switching circuit 160, and includes a variable attenuator capable of varying a level of attenuation. As will be discussed later, the reducing circuit 150 reduces the strength (amplitude) of the modulated wave (modulated signal).

The comparator 180 includes two input terminals. The first input terminal connects to the signal line SL1, and the voltage Vs on the signal line (hereinafter also termed “signal line voltage”) is applied to the first input terminal. A reference voltage Vref1 is applied to the second input terminal.

In this embodiment, the signal line voltage Vs varies according to an antenna module which is connected (discussed later). If the reference voltage Vref1 is higher than the signal line voltage Vs, the comparator 180 outputs “1” (H level), whereas if lower it outputs “0” (L level). An output terminal of the comparator 180 is connected to the CPU 110.

Note that to the signal line SL1, a capacitor C1 is series-connected, comparator 180 is connected to the CPU 110.

Note that to the signal line SL1, a capacitor C1 is series-connected, and a resistor R1 and an inductor L1 are parallel-connected. The capacitor C1 is provided for the purpose of eliminating the DC component. The resistor R1 is a pull-up resistor connected to an internal power source voltage Vo of the AP 100. The inductor L1 is disposed between the first input terminal of the comparator 180 and the signal line SL1, and is provided for the purpose of presenting the comparator 180 with the DC component only.

A coupler 145 is disposed between the second amplifier 144 and the reducing circuit 150. A rectifier 146 is disposed between the coupler 145 and the processing circuit 120. The coupler 145 detects the modulated wave (modulated signal) passing through the transmit signal line TL, and outputs a detector signal. The rectifier 146 rectifies the detector signal provided from the coupler 145. The rectified signal is supplied to the processing circuit 120. By employing this arrangement, the processing circuit 120 can control the strength of the modulated wave (modulated signal) output by the RF transceiver circuit 130, so as to be a prescribed value.

The CPU 110 reads out a program from ROM, RAM or other memories (not shown) connected to the bus, and executes processes according to the program.

Specifically, the CPU 110 supplies the processing circuit 120 with digital signals for transmission, and acquires received digital signals from the processing circuit 120.

Further, the CPU 110 controls the operations of the processing circuit 120, the RF transceiver circuit 130 or other circuits. Specifically, according to a frequency band to be used which has been preset by a user, the CPU 110 determines the frequency of the carrier wave to be generated by the RF transceiver circuit 130. Note that the user can set the frequency band to be used via a settings screen prepared by a Web server program that is provided in the AP 100.

In particular, in this embodiment, CPU 110 varies the level of attenuation of the reducing circuit 150 depending on the output of the comparator 180 (discussed later). The CPU 110 also controls the notifying section 190 depending on the output of the comparator 180.

The notifying section 190 performs notification to the user according to instructions from the CPU 110. The notifying section 190 may performs notification by a display using such as an LED, or by a sound using a speaker. In particular, in this embodiment, the notifying section 190 performs notification depending on the output of the comparator 180, according to instructions from the CPU 110 (discussed later).

Note that the comparator 180 and the CPU 110 of this embodiment correspond to an acquiring section of the present invention, and the processing circuit 120 and the RF transceiver circuit 130 correspond to a generating section. The CPU 110 corresponds to a controlling section, and the reducing circuit 150 corresponds to a reducing section.

While in the embodiment the CPU 110 and the processing circuit 120 are constituted as separate chips, it would be possible instead to provide a single chip having the functions of both CPU and processing circuit.

A-1-2. Internal Arrangement of Antenna Module:

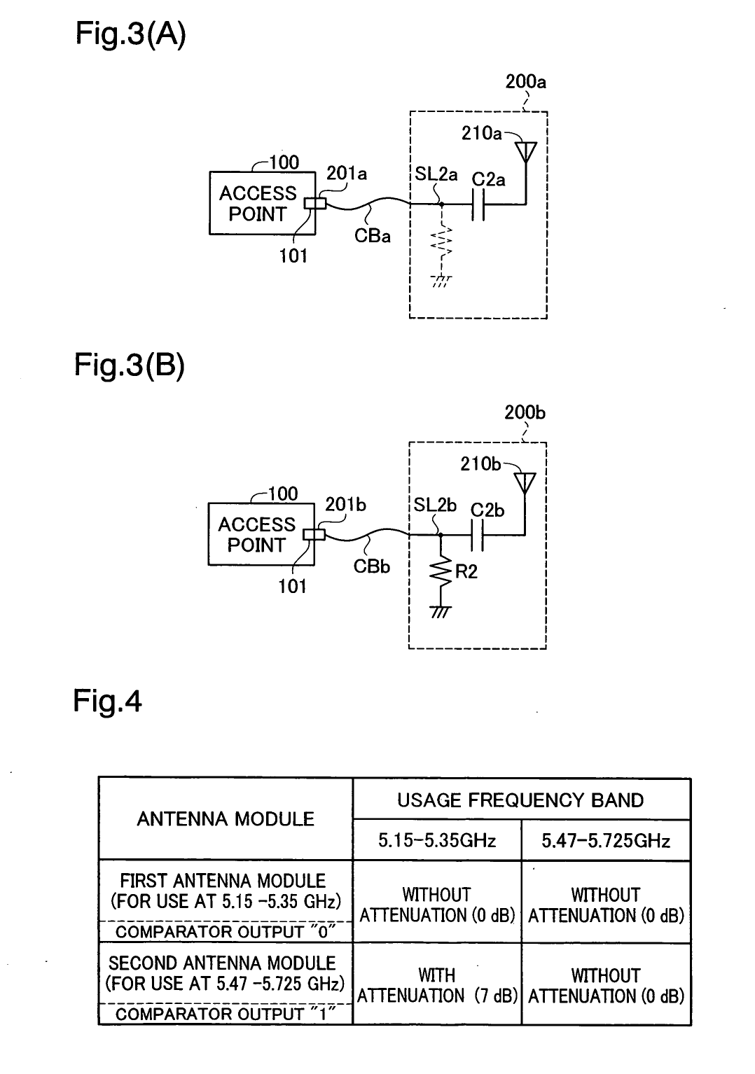

FIGS. 3(A) and 3(B) show the internal arrangement of the antenna module 200. FIG. 3(A) depicts a first antenna module 200a and FIG. 3(B) depicts a second antenna module 200b.

The first antenna module 200a shown in FIG. 3(A) comprises a connector 201a and an antenna element 210a. The connector 201a and the antenna element 210a are connected via a cable CBa and a signal line SL2a.

The antenna element 210a has antenna gain of 0 dBi. “dBi” signifies a value based on a non-directional antenna. Antenna gain is determined according to the structure of the antenna element 210a. The antenna element 210a resonates at the first frequency band. However, the antenna element 210a can also operate at the second frequency band.

A capacitor C2a is series-connected to the signal line SL2a. Note that the capacitor C2a, like the capacitor Cl in the AP 100, is provided for the purpose of eliminating the DC component.

The second antenna module 200b shown in FIG. 3(B) comprises a connector 201b and an antenna element 210b. The connector 201b and the antenna element 210b are connected via a cable CBb and a signal line SL2b.

The antenna element 210b has antenna gain of 7 dBi. The antenna element 210a resonates at the second frequency band. However, the antenna element 210a can also operate at the first frequency band.

A capacitor C2b is series-connected to the signal line SL2b, similar to FIG. 3(A).

Additionally, a resistor R2 is parallel-connected to the signal line SL2b. The resistor R2 is a pull-down resistor connected to the ground.

As will be understood by comparing FIGS. 3(A) and 3(B), whereas the first antenna module 200a having relatively low antenna gain (0 dBi) is not furnished with a pull-down resistor, the second antenna module having relatively high antenna gain (7 dBi) is furnished with the pull-down resistor R2.

In other words, the first antenna module 200a having relatively low antenna gain (0 dBi) is furnished with a virtual pull-down resistor of relatively high resistance value (∞Ω), while the second antenna module 200b having relatively high antenna gain (7 dBi) is furnished with a pull-down resistor of relatively low resistance value. In this way, in this embodiment, pull-down resistance value is established in association with antenna gain.

A-2. Standards:

According to the standards (standards for Low Power Data Communications System) for the first frequency band (5.15-5.35 GHz), the output power of the AP 100 is restricted to no more than 10 mW/MHz, and the antenna gain of the antenna module 200 is restricted to no more than 0 dBi. In other words, the value of the EIRP (Effective Isotropic Radiated Power or Equivalent Isotropic(ally) Radiated Power) of the AP 100 and the antenna module 200 in combination is restricted to no more than 10 dBm/MHz. Note that the EIRP (dB) is expressed as Pt (dB)+Ga (dB), where Pt (dB) denotes transmitter output and Ga (dB) denotes antenna gain.

Standards for the second frequency band (5.47-5.725 GHz) have not been established at present time. However, according to the standards for the second frequency currently expected to be established in the future, the output power of the AP 100 is restricted to no more than 10 mW/MHz, and the antenna gain is restricted to no more than 7 dBi. In other words, the value of the Effective Isotropic Radiated Power (EIRP) of the AP 100 and the antenna module 200 in combination is restricted to no more than 17 dBm/MHz.

In this embodiment, the output power of the AP 100 is set to 10 mW/MHz in the state with the reducing circuit 150 absent.

Incidentally, in this embodiment, the connectors 201a, 201b of the two antenna modules shown in FIG. 2 have the same shape, and are connectable to the connector 101 of the AP 100. That is, the AP 100 is connectable with both the first antenna module 200a suitable for use in the first frequency band, and the second antenna module 200b suitable for use in the second frequency band.

However, as described with reference to FIG. 2, the first antenna module 200a is capable in actual practice of emitting radio waves of the second frequency band. Similarly, the second antenna module 200b is capable in actual practice of emitting radio waves of the first frequency band. That is, even when the frequency band used by the AP 100 (hereinafter also referred to as the “usage frequency band”) and the resonance frequency of the antenna element do not match, the AP 100 can emit radio waves in the usage frequency band, via the connected antenna module.

Consequently, where the usage frequency band of the AP 100 is the first frequency band, if the second antenna module 200b having relatively high antenna gain (7 dBi) is connected to the AP 100, a strong radio wave (17 dBm/MHz) will be emitted, and the standards for the first frequency band will not be satisfied. Therefore, in the embodiment, pull-down resistance value is utilized in order to suppress emitting a strong radio wave.

A-3. Operation of Access Point:

FIG. 4 shows an overview of operation of the access point 100. As described previously, the AP 100 is capable of communication utilizing the first frequency band (5.15-5.35 GHz), as well as being capable of communication utilizing the second frequency band (5.47-5.725 GHz).

A-3-1. Operation if Usage Frequency Band is First Frequency Band:

The description turns first to the case of operation of the AP 100 where the usage frequency band is the first frequency band (5.15-5.35 GHz).

If the first antenna module 200a (FIG. 3(A)) suitable for use in the first frequency band is connected to the AP 100, the value of the signal line voltage Vs given to the comparator 180 is substantially equal to the value of the internal power source voltage Vo (e.g. 3.3 V). In this embodiment, the value of the reference voltage Vref1 is set to 2 V, for example. Consequently, the value of the reference voltage Vref1 (2 V) is smaller than the value of the signal line voltage Vs (3.3 V), and the output of the comparator 180 is set to “0” (L level) (see FIG. 4).

On the other hand, if the second antenna module 200b (FIG. 3(B)) suitable for use in the second frequency band is connected to the AP 100, the value of the signal line voltage Vs given to the comparator 180 is substantially equal to Vo×R2/(R1+R2). In this embodiment, the pull-down resistor R2 has substantially the same resistance value as the pull-up resistor R1. Consequently, the value of the reference voltage Vref1 (2 V) is greater than the value of the signal line voltage Vs (about 1.6 V), and the output of the comparator 180 is set to “1” (H level) (see FIG. 4).

As will be understood from the preceding description, the value of the reference voltage Vref1 may be set to a value lying between the first value (Vo) of the signal line voltage Vs when the first antenna module 200a is connected and the second value (Vo×R2/(R1+R2)) of the signal line voltage Vs when the second antenna module 200a is connected.

The CPU 110 sets the level of attenuation for the reducing circuit 150 depending on the output of the comparator 180. In the embodiment, the attenuation level is set to either “Without Attenuation (0 dB)” or “With Attenuation (7 dB).”

Specifically, as shown in FIG. 4, if the output of the comparator 180 is “0,” in other words, if the first antenna module 200a has been connected, the CPU 110 sets the attenuation level of the reducing circuit 150 to “Without Attenuation (0 dB).” On the other hand, if the output of the comparator 180 is “1,” in other words, where the second antenna module 200b has been connected, the CPU 110 sets the attenuation level of the reducing circuit 150 to “With Attenuation (7 dB).”

Thus, if the first antenna module 200a having relatively low antenna gain (0 dBi) has been connected, the modulated wave (modulated signal) output from the RF transceiver circuit 130 is not reduced in strength, and the AP 100 can emit radio wave having strength (10 dBm/MHz) that satisfies the standards. On the other hand, if the second antenna module 200b having relatively high antenna gain (7 dBi) has been connected, the modulated wave (modulated signal) output from the RF transceiver circuit 130 is reduced in strength, and consequently the AP 100 can emit radio wave having strength (10 dBm/MHz) that satisfies the standards, so as to avoid emitting radio wave of strength (17 dBm/MHz) not satisfying the standards.

The CPU 110 also controls the notifying section 190 to perform notification to the user, depending on the output of the comparator 180. For example, if the output of the comparator 180 is “0” (i.e. if the first antenna module 200a has been connected), the CPU 110 notifies the user that the connected antenna module is suitable for transmitting radio wave of the usage frequency band. On the other hand, if the output of the comparator 180 is “1” (i.e. where the second antenna module 200b has been connected), the CPU 110 notifies the user that the connected antenna module is not suitable for transmitting radio wave of the usage frequency band. When notified of the latter case, the user may quickly take appropriate countermeasures such as changing antenna modules. Note that it is also possible for the notification to be performed in the latter case only.

A-3-2. Operation if Usage Frequency Band is Second Frequency Band:

The description turns next to the case of operation of the AP 100 where the usage frequency band is the second frequency band (5.47-5.725 GHz).

As mentioned previously, if the first antenna module 200a suitable for use in the first frequency band has been connected to the AP 100, the output of the comparator 180 is set to “0” (L level). Further, if the second antenna module 200b suitable for use in the second frequency band has been connected to the AP 100, the output of the comparator 180 is set to “1” (H level).

The CPU 110 sets the level of attenuation for the reducing circuit 150 depending on the output of the comparator 180. Specifically, as depicted in FIG. 4, if the output of the comparator 180 is “0” (if the first antenna module 200a has been connected), the CPU 110 sets the attenuation level of the reducing circuit 150 to “Without Attenuation (0 dB).” Further, if the output of the comparator 180 is “1” (if the second antenna module 200b has been connected), the CPU 110 sets the attenuation level of the reducing circuit 150 to “With Attenuation (7 dB).”

Thus, both in the case that the first antenna module 200a having relatively low antenna gain (0 dBi) has been connected, and in the case that the second antenna module 200b having relatively high antenna gain (7 dBi) has been connected, the modulated wave (modulated signal) output by the RF transceiver circuit 130 is not reduced in strength, and the AP 100 can emit radio wave of strength that satisfies the standards. However, in the case that the first antenna module 200a has been connected, the power of the emitted radio wave becomes a value lower by 7 dB than the upper limit (17 dBm/MHz) defined in the standards (i.e. 10 dBm/MHz).

In this embodiment, the attenuation level is set to either “Without Attenuation (0 dB)” or “With Attenuation (7 dB).” Thus, the reducing circuit 150 may include an SPST (Single Pole Single Throw) type analog switch, instead of a variable attenuator. It is common knowledge that, with an analog switch, it is difficult to completely block high frequency signals, even when set to the OFF state. Thus, it is possible to utilize an analog switch having an appropriate level of attenuation (7 dB for example) as the reducing circuit.

A-4. Modification Example of First Embodiment:

In the first embodiment (FIG. 1), it was assumed that one of two types of antenna modules 200a, 200b is connected to the AP 100; however, there may be cases in which any one of three or more types of antenna modules could be connected. In this example, a case in which any one of three or more types of antenna modules could be connected is described.

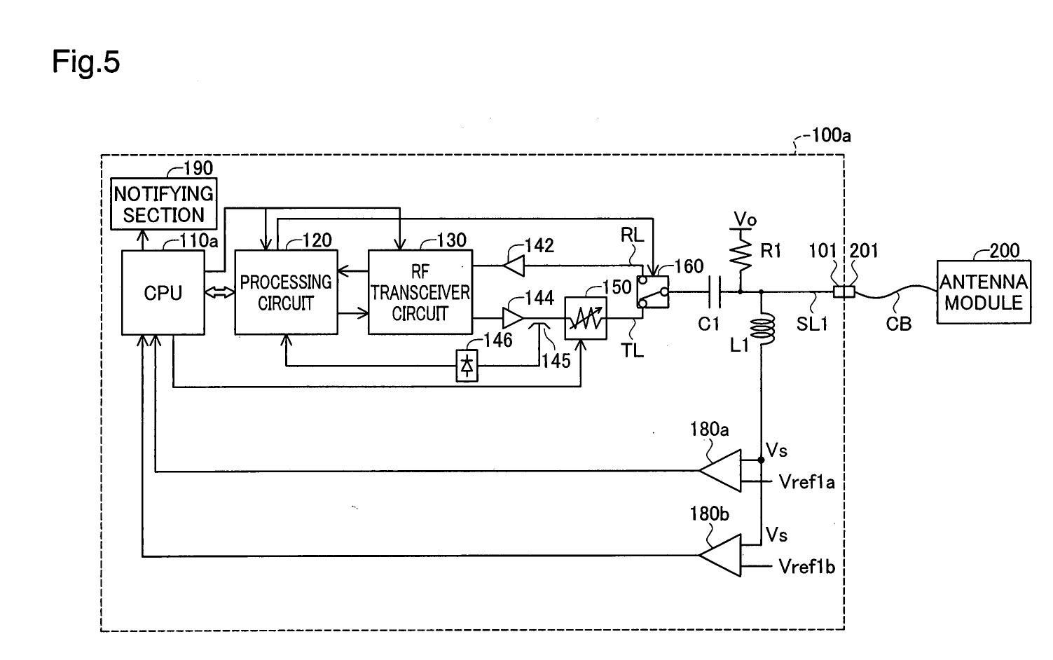

FIG. 5 shows the internal arrangement of an access point 100a according to a modification example of the first embodiment. FIG. 5 is substantially similar to FIG. 2, but two comparators 180a, 180b are provided. Further, a CPU 110a is modified in association with this modification.

Like the comparator 180 of FIG. 2, the signal line voltage Vs is applied to the first input terminal of each of the comparators 180a, 180b, and reference voltages Vref1a, Vref1b are respectively applied to the second input terminals of the comparators 180a, 180b. However, the values of the reference voltages Vrefla, Vreflb differ from one another. The output of each of the comparators 180a, 180b is supplied to the CPU 110a.

By employing the arrangement of FIG. 5, it is possible to control the reducing circuit 150 depending on three types of antenna modules having mutually different levels of antenna gain. Specifically, the CPU 110a can determine which of the three types of antenna modules has been connected, depending on the two outputs (2-bit output) from the two comparators 180a, 180b. The two comparators 180a, 180b indicate mutually different 2-bit values in the following instances: where the value of the signal line voltage Vs is smaller than the value of the first reference voltage Vref1a; where the value of the signal line voltage Vs lies between the value of the first reference voltage Vref1a and the value of the second reference voltage Vref1b; and where the value of the signal line voltage Vs is greater than the value of the second reference voltage Vref1b.

In the modification example of the first embodiment, three different attenuation levels can be set depending of the pull-down resistance values of three different antenna modules, in other words, depending on three different levels of antenna gain.

Note that if n types of antenna modules having mutually different levels of antenna gain is connected, (n−1) comparators may be provided.

As discussed above, in this embodiment (and the modification example thereof), the CPU 110 (110a) varies the attenuation level of the reducing circuit 150, depending on the usage frequency band and the output of the comparator 180 (180a, 180b). By so doing, the strength of the modulated wave (modulated signal) can be reduced so that the strength of radio wave emitted from the antenna module does not exceed the upper limit defined in the standards for the usage frequency band. As a result, emission of strong radio wave due to a mismatched combination of the antenna module and the AP can be suppressed.

In particular, in this embodiment (and the modification example thereof, even if an antenna module having excessively high antenna gain is connected, radio wave with reduced strength is emitted, so that the AP can carry out wireless communication with satisfying standards.

### B. Second Embodiment:

B-1. Internal Arrangement of Access Point:

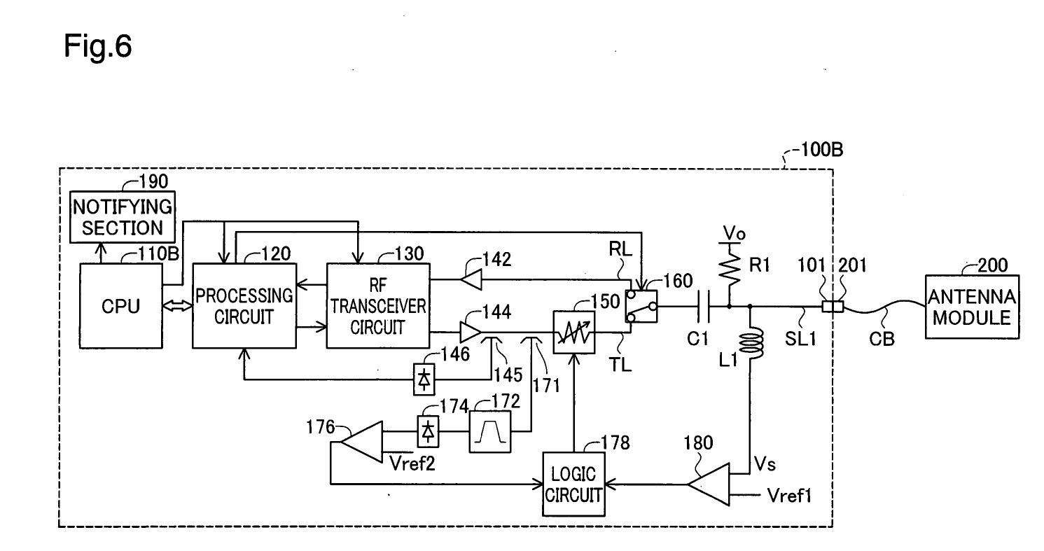

FIG. 6 shows the internal arrangement of an access point 100B in the second embodiment. FIG. 6 is substantially similar to FIG. 2, but a second coupler 171, a filter 172, a second rectifier 174, a second comparator 176, and a logic circuit 178 are added. Further, a CPU 110B is modified in association with this modification. Specifically, whereas in the first embodiment (FIG. 2) the CPU 110 sets the attenuation level of the reducing circuit 150, in the present embodiment, the logic circuit 178 sets the attenuation level of the reducing circuit 150.

The second coupler 171 is disposed between the first coupler 145 and the reducing circuit 150. The second coupler 171, like the first coupler 145, detects the modulated wave (modulated signal) passing through the transmit signal line TL, and outputs a second detector signal.

The filter 172 is a band-pass filter that allows signal components of a prescribed frequency band in the second detector signal to pass, while prohibiting passage of signal components of other frequency bands. In this embodiment, the filter 172 allows a signal components in the first frequency band (5.15-5.35 GHz) to pass, while prohibiting passage of signal components of the second frequency band (5.47-5.725 GHz).

The second rectifier 174 rectifies the filtered signal output from the filter 172. The rectified signal is supplied to the second comparator 176.

The second comparator 176 includes two input terminals. The first input terminal is connected with the second rectifier 174, and a prescribed reference voltage Vref2 is applied to the second input terminal. If the voltage of the rectified signal supplied to the first input terminal is higher than the reference voltage Vref2, the second comparator 176 outputs “1” (H level), whereas if lower it outputs “0” (L level).

In this embodiment, the logic circuit 178 is constituted by an AND circuit. Specifically, if the outputs of the two comparators 176, 180 are both “1” (H level) the logic circuit outputs “1” (H level), and in other instances it outputs “0” (L level).

Note that the comparator 180 and the logic circuit 178 of this embodiment correspond to an acquiring section of the present invention, and the processing circuit 120 and the RF transceiver circuit 130 correspond to a generating section. The coupler 171, the filter 172, the rectifier 174, and the comparator 176 correspond to a detector circuit; and the coupler 171, the filter 172, the rectifier 174, the comparator 176 and the logic circuit 178 correspond to a controlling section.

B-2. Operation of Access Point:

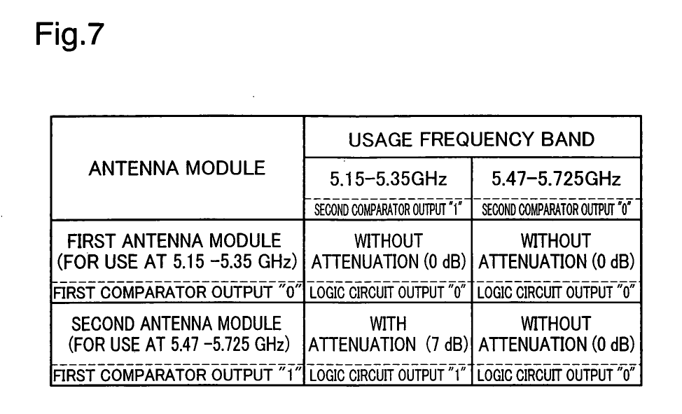

FIG. 7 shows an overview of operation of the access point 100B. As described in the first embodiment (FIG. 4), if the first antenna module 200a suitable for use in the first frequency band is connected to the AP 100B, the output of the first comparator 180 is set to “0” (L level). On the other hand, if the second antenna module 200b suitable for use in the second frequency band is connected to the AP 100B, the output of the first comparator 180 is set to “1” (H level).

B-2-1. Operation If Usage frequency band Is First Frequency Band

The description turns first to the case of operation of the AP 100B where the usage frequency band is the first frequency band (5.15-5.35 GHz).

Since the usage frequency band is the first frequency band (5.15-5.35 GHz), the output of the second comparator 176 is set to “1” (H level).

This is because signal component of the first frequency band is allowed to pass through the filter 172, and the second comparator 176 is supplied with a rectified signal of relatively high level from the second rectifier 174.

The logic circuit 178 sets the attenuation level of the reducing circuit 150 depending on the outputs of the two comparators 176, 180. Specifically, if the output of the first comparator 180 is “0” (if the first antenna module 200a has been connected), the logic circuit 178 outputs “0,” and sets the attenuation level of the reducing circuit 150 to “Without Attenuation (0 dB).” On the other hand, if the output of the first comparator 180 is “1” (if the second antenna module 200b has been connected), the logic circuit 178 outputs “1,” and sets the attenuation level of the reducing circuit 150 to “With Attenuation (7 dB).”

Consequently, if the first antenna module 200a having relatively low antenna gain (0 dBi) has been connected, the modulated wave (modulated signal) output by the RF transceiver circuit 130 is not reduced in strength, and the AP 100B can emit radio wave having strength (10 dBm/MHz) that satisfies the standards. On the other hand, if the second antenna module 200b having relatively high antenna gain (7 dBi) has been connected, the modulated wave (modulated signal) output by the RF transceiver circuit 130 is reduced in strength, and consequently the AP 100B can emit radio wave having strength (10 dBm/MHz) that satisfies the standards, so as to avoid emitting radio wave of strength (17 dBm/MHz) not satisfying the standards.

B-2-2. Operation if Usage Frequency Band is Second Frequency Band:

The description turns next to the case of operation of the AP 100B where the usage frequency band is the second frequency band (5.47-5.725 GHz).

Since the usage frequency band is the second frequency band (5.47-5.725 GHz), the output of the second comparator 176 is set to “0” (L level). This is because signal component of the second frequency band is prevented from passing through the filter 172, and the second comparator 176 is supplied with a rectified signal of zero level from the second rectifier 174.

The logic circuit 178 sets the attenuation level of the reducing circuit 150 depending on the outputs of the two comparators 176, 180. Specifically, if the output of the first comparator 180 is “0” (if the first antenna module 200a has been connected), the logic circuit 178 outputs “0,” and sets the attenuation level of the reducing circuit 150 to “Without Attenuation (0 dB).” If the output of the first comparator 180 is “1” (if the second antenna module 200b has been connected) as well, the logic circuit 178 outputs “0,” and sets the attenuation level of the reducing circuit 150 to “Without Attenuation (0 dB).”

Consequently, both in the case that the first antenna module 200a having relatively. low antenna gain (0 dBi) has been connected, and in the case that the second antenna module 200b having relatively high antenna gain (7 dBi) has been connected, the modulated wave (modulated signal) output by the RF transceiver circuit 130 is not reduced in strength, and the AP 100B can emit radio wave having strength that satisfies the standards. However, in the case that the first antenna module 200a has been connected, the power of the emitted radio wave becomes a value lower by 7 dB than the upper limit (17 dBm/MHz) defined in the standards (i.e. 10 dBm/MHz).

Note that in this embodiment as well, as discusses in the first embodiment, the reducing circuit 150 may include an SPST type analog switch, instead of a variable attenuator.

B-3. Modification Example of Second Embodiment

In the second embodiment (FIG. 6), since the RF transceiver circuit 130 of the AP 100B is capable of generating carrier waves of two different frequencies, it can generate modulated waves (modulated signals) of two different frequency bands. Thus, in the second embodiment, the filter 172 is utilized to detect whether the usage frequency band is the first frequency band or the second frequency band. In this example, a case in which the RF transceiver is capable of generating carrier waves of three or more different frequencies, and it can generate modulated waves (modulated signals) of three or more different frequency bands.

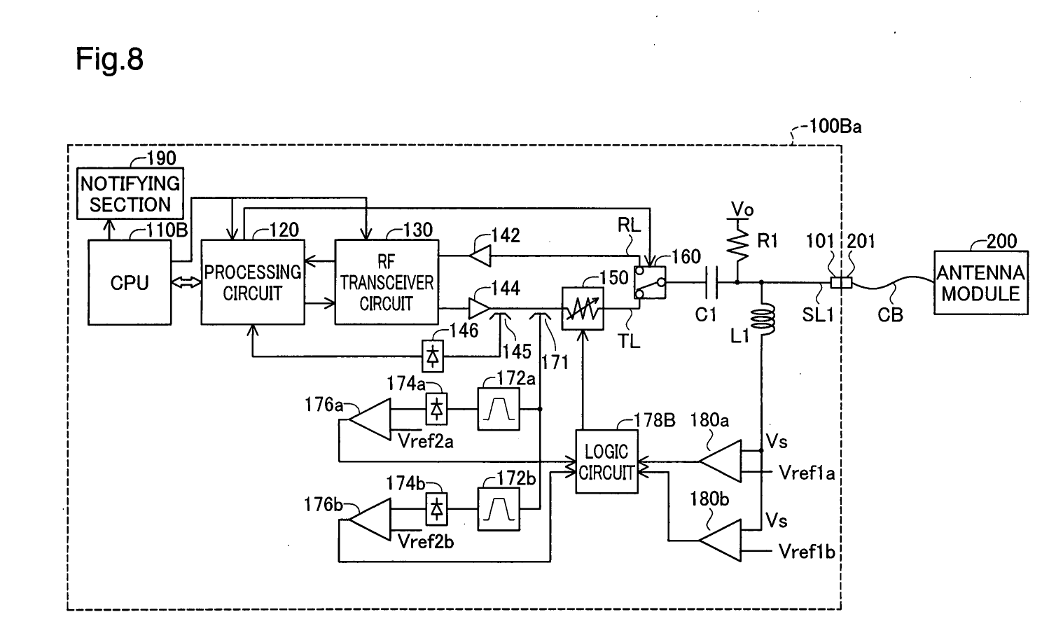

FIG. 8 shows the internal arrangement of the access point 100Ba in the modification example of the second embodiment. FIG. 8 is substantially similar to FIG. 6, but a RF transceiver circuit 130B is modified. The RF transceiver circuit 130B is capable of generating carrier waves of three different frequencies. In association with this modification, there are provided two sets of filters 172a, 172b, second rectifiers 174a, 174b, and second comparators 176a, 176b. Further, a logic circuit 178B is modified. Note that in FIG. 8, as in the modification example of the first embodiment (FIG. 5), two first comparators 180a, 180b are provided. However, in this example, the output of each of the first comparators 180a, 180b is supplied to the logic circuit 178B.

The two filters 172a, 172b are each connected to the coupler 171. The filtered signals output from the filters 172a, 172b are supplied to the corresponding second rectifiers 174a, 174b, respectively. The rectified signals output from the rectifiers 174a, 174b are supplied to the corresponding second comparators 176a, 176b, respectively. The outputs of the comparators 176a, 176b are then supplied to the logic circuit 178B. Note that in this example, reference voltages Vref2a, Vref2b given to the comparators 176a, 176b are set to the same value, but may be set to different values instead.

By employing the arrangement of FIG. 8, it is possible to control the reducing circuit 150 depending on which of three mutually different frequency bands is used. Specifically, the filters 172a, 172b are band-pass filters that allow signal components of mutually different prescribed frequency bands to pass. The logic circuit 178B determines which of the three different frequency bands is being used, depending on the two outputs (2-bit output) from the two comparators 176a, 176b. The two comparators 176a, 176b indicate mutually different 2-bit values in the case where the first frequency band is used, in the case where the second frequency band is used, and in the case where the third frequency band is used. The logic circuit 178B can vary the attenuation level of the reducing circuit 150 depending on the detected usage frequency band and the connected antenna module.

Note that if n types of mutually different frequency bands is used, (n−1) detector circuits may be provided.

Moreover, by employing the arrangement of FIG. 8, as with FIG. 5, the attenuation level of the reducing circuit 150 can be varied depending on three types of antenna modules having mutually different levels of antenna gain.

As discussed above, in this embodiment (and the modification example thereof), the logic circuit 178 (178B) varies the attenuation level of the reducing circuit 150 depending on the output of the second comparator 176 (176a, 176b) and the output of the first comparator 180 (180a, 180b). By so doing, the strength of the modulated wave (modulated signal) can be reduced so that the strength of radio wave emitted from the antenna module does not exceed the upper limit defined in the standards for the usage frequency band. As a result, emission of strong radio wave due to a mismatched combination of the antenna module and the AP can be suppressed.

### C. Third Embodiment

C-1. Internal Arrangement of Access Point:

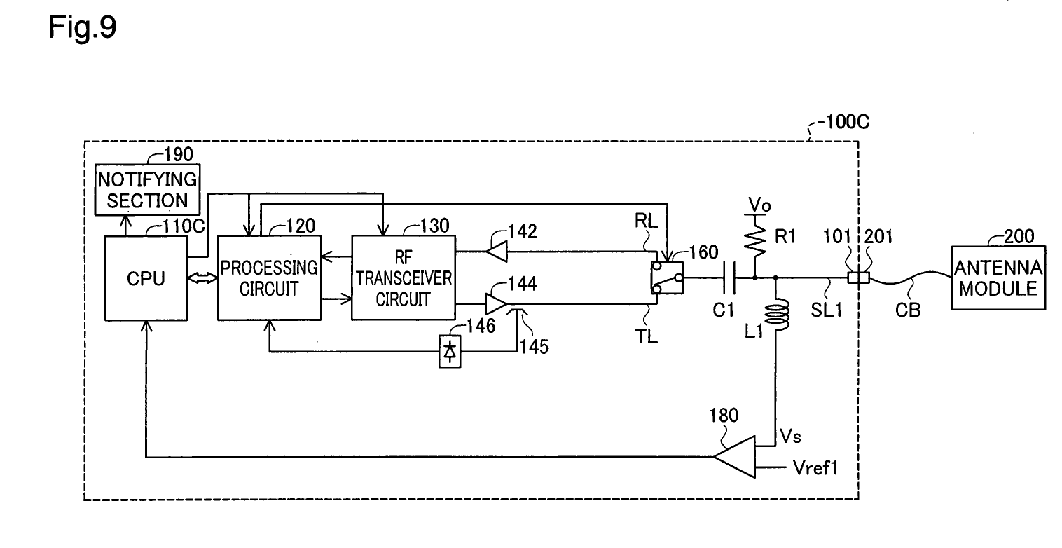

FIG. 9 shows the internal arrangement of an access point 100C in the third embodiment. FIG. 9 is substantially similar to FIG. 2, but the reducing circuit 150 is omitted, and a CPU 110C is modified.

Whereas in the first embodiment (FIG. 2) the CPU 110 sets the attenuation level of the reducing circuit 150 depending on the output of the comparator 180, in this embodiment, the CPU 110C controls the processing circuit 120 and the RF transceiver circuit 130 depending on the output of the comparator 180.

Specifically, the CPU 110C adjusts the target gain of a group of amplifiers provided in the processing circuit 120 and the RF transceiver circuit 130, depending on the output of the comparator 180. In this embodiment, the output power of the AP 100C is adjusted thereby.

Note that the comparator 180 and the CPU 110C of this embodiment correspond to an acquiring section of the present invention, and the processing circuit 120 and the RF transceiver circuit 130 correspond to a generating section. The CPU 110C corresponds to a controlling section.

C-2. Operation of Access Point:

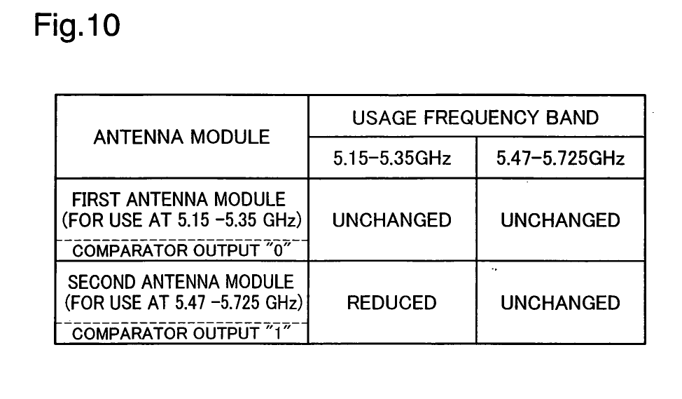

FIG. 10 shows an overview of operation of the access point 100C. As described in the first embodiment (FIG. 4), if the first antenna module 200a suitable for use in the first frequency band is connected to the AP 100C, the output of the first comparator 180 is set to “0” (L level). On the other hand, if the second antenna module 200b suitable for use in the second frequency band is connected to the AP 100C, the output of the first comparator 180 is set to “1” (H level).

C-2-1. Operation if Usage Frequency Band is First Frequency Band:

The description turns first to the case of operation of the AP 100C where the usage frequency band is the first frequency band (6.15-5.35 GHz).

The CPU 110C determines operation of the processing circuit 120 and the RF transceiver circuit 130 depending on the output of the comparator 180. Specifically, as shown in FIG. 10, if the output of the comparator is “0” (if the first antenna module 200a has been connected), the CPU 110C sets the target gain of the group of amplifiers within the processing circuit 120 and the RF transceiver circuit 130 to an initial value, without changing the target gain. On the other hand, if the output of the comparator is “1” (if the second antenna module 200b has been connected), the CPU 110C decreases the target gain of the group of amplifiers within the processing circuit 120 and the RF transceiver circuit 130, from its the initial value. The gain of each of the amplifiers making up the amplifier group within the processing circuit 120 and the RF transceiver circuit 130 is determined such that the target gain of the amplifier group is lower than the initial value by 7 dB.

Consequently, if the first antenna module 200a having relatively low antenna gain (0 dBi) has been connected, the modulated wave (modulated signal) generated by the processing circuit 120 and the RF transceiver circuit 130 is not reduced in strength, and the AP 100C can emit radio wave having strength (10 dBm/MHz) that satisfies the standards. On the other hand, if the second antenna module 200b having relatively high antenna gain (7 dBi) has been connected, the modulated wave (modulated signal) generated by the processing circuit 120 and the RF transceiver circuit 130 is reduced in strength, and consequently the AP 100C can emit radio wave of strength (10 dBm/MHz) that satisfies the standards, so as to avoid emitting radio wave of strength (17 dBm/MHz) not satisfying the standards.

C-2-2. Operation if Usage Frequency Band is Second Frequency Band:

The description turns next to the case of operation of the AP 100C where the usage frequency band is the second frequency band (5.47-5.725 GHz).

The CPU 110C determines operation of the processing circuit 120 and the RF transceiver circuit 130 depending on the output of the comparator 180. Specifically, as shown in FIG. 10, if the output of the comparator is “0” (if the first antenna module 200a has been connected), the CPU 110C sets the target gain of the group of amplifiers within the processing circuit 120 and the RF transceiver circuit 130 to an initial value, without changing the target gain. If the output of the comparator is “1” (if the second antenna module 200b has been connected) as well, the CPU 110C sets the target gain of the group of amplifiers within the processing circuit 120 and the RF transceiver circuit 130 to an initial value, without changing the target gain.

Consequently, both in the case that the first antenna module 200a having relatively low antenna gain (0 dBi) has been connected, and in the case that the second antenna module 200b having relatively high antenna gain (7 dBi) has been connected, the modulated wave (modulated signal) generated by the processing circuit 120 and the RF transceiver circuit 130 is not reduced in strength, and the AP 100C can emit radio wave of strength that satisfies the standards. However, in the case that the first antenna module 200a has been connected, the power of the emitted radio wave becomes a value lower by 7 dB than the upper limit (17 dBm/MHz) defined in the standards(i.e. 10 dBm/MHz).

As discussed above, in this embodiment, the CPU 110C changes the target gain of the group of amplifiers within the processing circuit 120 and the RF transceiver circuit 130, depending on the usage frequency band and the output of the comparator 180. By so doing, the strength of the modulated wave (modulated signal) can be reduced so that the strength of radio wave emitted from the antenna module does not exceed the upper limit defined in the standards for the usage frequency band. As a result, emission of strong radio waves due to a mismatched combination of the antenna module and the AP can be suppressed.

In this embodiment, as in the modification example of the first embodiment (FIG. 5), where a plurality of comparators are provided, the target gain of the group of amplifiers within the processing circuit 120 and the RF transceiver circuit 130 can be changed depending on a plural types of antenna modules having mutually different antenna gain.

In the embodiment, the CPU 110C changes the gain of one or more amplifiers in the processing circuit 120 and one or more amplifiers in the RF transceiver circuit 130, depending on the output of the comparator 180. But, instead of this, the gain of the amplifier(s) within only one of the two circuits 120, 130(e.g. the RF transceiver circuit 130) may be changed.

The invention is not limited to the above examples and embodiments set forth hereinabove, and can be reduced to practice in various ways without departing from the spirit thereof, such as the following variations, for example.

(1) In the above embodiments, the CPU 110 acquires the output of the comparator 180, the output being determined on the basis of pull-down resistance value corresponding to antenna gain. But, instead of this, the CPU 110 may acquire the signal line voltage Vs determined on the basis of pull-down resistance value. Note that in this case, an A/D converter may be used in place of the comparator 180, and the A/D converter may supply the CPU 110 with a digital value indicating the signal line voltage Vs.

In the above embodiments, information relating to antenna gain is acquired via the signal line over which the modulated wave(modulated signal) transmitted, but instead of this, the information may be acquired by other methods. For example, the information relating to antenna gain may be stored in memory provided within the antenna module, and the information read out via other signal line connecting the antenna module with the AP.

In general, information relating to antenna gain will be acquired from an antenna module.

(2) In the first and second embodiments, the strength of the modulated wave (modulated signal) output from the RF transceiver circuit is reduced by means of controlling the reducing circuit. In the third embodiment on the other hand, the strength of the modulated wave (modulated signal) generated by the processing circuit and the RF transceiver circuit is reduced by means of controlling the processing circuit and the RF transceiver circuit. However, instead of these, both control of the reducing circuit, and control of the processing circuit and the RF transceiver circuit may be executed.

In general, a reducing process for reducing strength of radio wave emitted from a antenna module will be executed.

(3) In the above embodiments, in instances where there is a risk that the strength of the radio waves emitted from the antenna module may exceed the upper limit defined in the standards, the strength of the modulated wave (modulated signal) output by the AP is reduced so as to emit radio waves of strength not exceeding the upper limit defined in the standards. However, it may be possible to instead prohibit the antenna module from emitting radio wave. By so doing, radio wave will not be emitted in the case where an antenna module having excessively high antenna gain has been connected. In this case, it may be acceptable to halt operation of circuits for transmission within the processing circuit 120 or the RF transceiver circuit 130. Alternatively, the switching circuit 160 may be forcibly set to a first state in which the receive signal line RL and the common signal line SL1 have electrical continuity, so that the modulated wave (modulated signal) is not transmitted from the transmit signal line TL to the common signal line SL1.

In general, on the basis of information related to antenna gain, predetermined processes will be executed such that strength of radio wave emitted from an antenna module responsive to modulated wave(modulated signal) does not exceed an upper limit of standards defined for a usage frequency band.

(4) In the above embodiments, if the first antenna module 200a is connected to the AP using the second frequency band, the power of the emitted radio wave is a value lower by 7 dB than the upper limit (17 dBm/MHz) defined in the standards (i.e. 10 dBm/MHz). However, in the above case, it may be acceptable to instead set the power of the emitted radio wave to the upper limit (17 dBm/MHz) defined in the standards. In this case, the target gain of the amplifier(s) within the processing circuit 120 and/or RF transceiver circuit 130 may be increased, for example.

(5) In the above embodiments the RF transceiver circuit 130 is capable of generating modulated waves (modulated signals) of two or more different frequency bands, but instead of this, the RF transceiver circuit 130 may be capable of generating a modulated wave (modulated signal) of one frequency band only.

In general, a modulated wave (modulated signal) of at least one specific frequency band will be generated.

(6) In the above embodiments the case where radio wave of the 5 GHz band is used is described, but the present invention may be applied to the cases where radio waves of other frequency bands are used.

Although the present invention has been described and illustrated in detail, it is clearly understood that the same is by way of illustration and example only and is not to be taken by way of limitation, the spirit and scope of the present invention being limited only by the terms of the appended claims.

1. A communication device to which an external antenna module is to be connected, the communication device comprising:
a connector that is connected to the antenna module;
a generating section that generates a transmitting signal of a specific frequency band, the transmitting signal being supplied to the antenna module via the connector;
an acquiring section that acquires information relating to antenna gain from the antenna module; and
a controlling section that executes predetermined processing on the basis of the information relating to antenna gain, such that strength of radio wave emitted from the antenna module responsive to the transmitting signal does not exceed an upper limit value defined for the specific frequency band.

2. A communication device according to claim 1, wherein the connector is connectable to a plurality of types of antenna modules having mutually different antenna gain.

3. A communication device according to claim 1, wherein the predetermined processing includes a reducing process for reducing the strength of the radio wave emitted from the antenna module, if the strength of the radio wave could exceed the upper limit value.

4. A communication device according to claim 3 further comprising:
a reducing section that reduces strength of the transmitting signal output from the generating section,
wherein the reducing process includes a process for controlling the reducing section to reduce the strength of the transmitting signal output from the generating section.

5. A communication device according to claim 4, wherein the reducing section includes a variable attenuator capable of varying a level of attenuation.

6. A communication device according to claim 3, wherein the reducing process includes a process for controlling the generating section to reduce strength of the transmitting signal that is to be generated by the generating section.

7. A communication device according to claim 1, wherein the predetermined processing includes a process for prohibiting emission of the radio wave, if the strength of the radio wave emitted from the antenna module could exceed the upper limit value.

8. A communication device according to claim 1, wherein the controlling section further comprises:
a detector circuit that detects a frequency band of the transmitting signal, using the transmitting signal generated by the generating section,
wherein the controlling section executes the predetermined processing using a result of the detection by the detector circuit.

9. A communication device according to claim 1, wherein the generating section is capable of generating a plurality of types of transmitting signals corresponding to a plurality of mutually different frequency bands, and
the generating section generates the transmitting signal of the specific frequency band that is any one of the plurality of mutually different frequency bands.

10. A communication device according to claim 3 further comprising:
a notifying section that performs notification to a user,
wherein the predetermined processing further includes a process for controlling the notifying section to perform the notification to the user, if the strength of the radio wave emitted from the antenna module could exceed the upper limit value.

11. A control method in a communication device including a connector that is to be connected to an external antenna module, the control method comprising:
generating a transmitting signal of a specific frequency band, the transmitting signal being supplied to the antenna module via the connector;
acquiring information relating to antenna gain from the antenna module; and
executing predetermined processing on the basis of the information relating to antenna gain, such that strength of radio wave emitted from the antenna module responsive to the transmitting signal does not exceed an upper limit value defined for the specific frequency band.

12. A control method according to claim 11, wherein the connector is connectable to a plurality of types of antenna modules having mutually different antenna gain.

13. A control method according to claim 11, wherein the predetermined processing includes a reducing process for reducing the strength of the radio wave emitted from the antenna module, if the strength of the radio wave could exceed the upper limit value.

14. A control method according to claim 13, wherein the communication device further includes a reducing section that reduces strength of the transmitting signal generated in the generating step, and wherein the reducing process is executed using the reducing section.

15. A control method according to claim 14, wherein the reducing section includes a variable attenuator capable of varying a level of attenuation.

16. A control method according to claim 13, wherein the reducing process is executed during execution of the generating step.

17. A control method according to claim 11, wherein the predetermined processing includes a process for prohibiting emission of the radio wave, if the strength of the radio wave emitted from the antenna module could exceed the upper limit value.

18. A control method according to claim 11, wherein the executing the predetermined processing step further includes:
detecting a frequency band of the transmitting signal, using the transmitting signal generated in the generating step,
and wherein the predetermined processing is executed using a result of the detection.

19. A control method according to claim 11, wherein the communication device is capable of generating a plurality of types of transmitting signals corresponding to a plurality of mutually different frequency bands,
and wherein the generating step includes:
generating the transmitting signal of the specific frequency band that is any one of the plurality of mutually different frequency bands.

20. A control method according to claim 13, wherein the predetermined processing further includes a process for performing notification to a user, if the strength of the radio wave emitted from the antenna module could exceed the upper limit value.
